(19) United States
(12) Patent Application Publication
(10) Pub. No.: US 2006/0268779 A1
(43) Pub. Date: Nov. 30, 2006

(54) Method for transmitting packet data in a radio telecommunications system

(76) Inventors: Frank Exeler, Rheine (DE); Anton Kruk, Hamminkein (DE); Andreas Müller, Rees (DE)

Correspondence Address: BELL, BOYD & LLOYD, LLC, P. O. BOX 1135, CHICAGO, IL, 60690-1135, US

(21) Appl. No.: 10/563,527

(22) PCT Filed: Feb. 26, 2004
(86) PCT No.: PCT/EP04/01940

§ 371 Date: Jan. 3, 2006

(30) Foreign Application Priority Data
Jul. 2, 2003 (DE) 10329878.9

(51) Int. Cl. H04Q 7/00

(52) U.S. Cl. 370/330

(57) ABSTRACT

A method for transmitting packet data in a radio telecommunications system including a plurality of radio transmitters and radio receivers that use a dynamic multiple access method for separating users at least by means of a time-slot separation method, in particular a “time division multiple access” (TDMA) method, in addition to methods for secure data transmission, in particular an “automatic repeat request” (ARQ) method. If a renewed transmission of a data packet is required, a repeat slot is inserted and frequencies are assigned to radio transmitters and radio receivers in such a way that each transmitter or receiver is allocated a unique identifying frequency. A frequency-slot separation method can be implemented for the duration of the repeat time-slot in such a way that a data packet to be repeated, which is destined for a radio transmitter or radio receiver, is transmitted on the frequency identifying said transmitter or receiver and in each radio transmitter or radio receiver a frequency is selected in such a way that said transmitter or receiver searches for a repeated data packet on their respective identifying frequency.

### FIELD OF TECHNOLOGY

The present disclosure relates to a method for transmitting packet data in a radio telecommunications system using dynamic multiple access under a TDMA configuration.

### BACKGROUND

Radio telecommunications systems currently use a time-slot separation method (time-division multiplex) for separating users during radio transmission. With such radio telecommunications systems, particularly operating in accordance with the Digital Enhanced Cordless Telecommunication standard, it can be advantageous because of the limited transmission capacity needed to dynamically allocate an available bandwidth to the individual generally mobile user stations (radio transmitters and radio receivers). However, in these systems, collisions can occur during the transmission of data packets. These occur, for example, if an Automatic Repeat Request (ARQ) method is used in accordance with a transmission protocol, because the transmission of individual data packets is repeated as part of this ARQ procedure, if a confirmation, i.e. a positive acknowledgement (ACK) of the receipt of a packet is absent and the existing resources thus become exhausted after a certain number of such repeat requests.

### SUMMARY

Accordingly, a method is presently disclosed that reduces the mutual interference between radio transmitters and radio receivers of a radio telecommunications system.

Under an exemplary embodiment, a radio telecommunications system includes a plurality of radio transmitters and radio receivers that use a dynamic multiple access method for separating users at least by means of a time-slot separation method, in particular a Time Division Multiple Access (TDMA) method in addition to methods for secure data transmission, particularly an Automatic Repeat Request (ARQ) method. If a renewed transmission of a data packet is required, a repeat time slot is inserted and frequencies are allocated to radio transmitters and radio receivers in such a way that each transmitter or receiver is allocated a unique identifying frequency. As a result, frequency slot separation methods can be implemented for the duration of the repeat time-slot in such a way that a data packet to be repeated, which is destined for a radio transmitter or radio receiver, is transmitted on the frequency identifying the transmitter or receiver. Furthermore, in each radio transmitter or radio receiver, a frequency is selected in such a way that the transmitters or receivers search for a repeated data packet on their respective identifying frequency.

Under the embodiment, it is possible to use a positive ACK in the transmission protocol in radio telecommunications systems that use a time-slot separation method. This is achieved mainly in that a frequency-slot separation method is used during the repeat time slot, so that even if several radio transmitters or radio receivers initiate a repeat transmission of data packets, no mutual blocking takes place. The method is also characterized by the fact that it is easy to implement, particularly in radio telecommunications systems that operate according to the DECT or WDCT standard.

In another embodiment, a single allocation of frequencies to radio transmitters/receivers is carried out in such a way that each radio transmitter/radio receiver is allocated a unique identifying frequency, particularly as part of an initialization of the radio coverage area, with the allocation being stored, at least temporarily, in the radio transmitters and radio receivers. This has the advantage that there is no charge for the resources of the radio telecommunications system due to this allocation step, but instead a radio transmitter/radio receiver in the following needs to access the stored allocation only if required.

Alternatively, the allocation step may be carried out at the start of each transmission frame in accordance with the time-slot separation method. In this way, it is possible to keep the radio transmitters and radio receivers in the most up-to-date status, so that flexible reaction is possible, for example if there are fluctuations in the overall number of radio transmitters and radio receivers.

Furthermore, the allocation of frequencies to radio transmitters and radio receivers may be arranged to be performed in such a way that each radio transmitter/radio receiver is assigned a sequence with an unambiguous starting value. This enables easier implementation, particularly in radio communications systems that operate in accordance with the WDCT standard.

If the steps are then carried out whereby a frequency-slot separation method can be implemented for the duration of the repeat time-slot in such a way that a data packet to be repeated is transmitted on the frequency identifying the transmitter or receiver. In each radio transmitter or receiver, a frequency can be selected in such a way that each of the transmitters or receivers search for a repeated data packet on their respective identifying frequency. If, in a radio coverage area of the radio telecommunications system, it is determined before the start of a transmission frame that a first number of radio transmitters and radio receivers in a radio coverage area exceeds a second number of repeat time-slots available in the radio coverage area in accordance with the time-slot separation method, energy resources are saved because the steps of the disclosed method are therefore only carried out if there is an actual danger of blocking the repeat time slots.

The aforementioned steps may also be carried out for each repeat time-slot. In this case, a determination of the radio transmitters and radio receivers in the radio coverage area is superfluous, thus resulting in a simplified implementation. This development can also be used additionally for the detection of radio transmitters and radio receivers and is advantageous because detection and particularly the signaling of the result can be minimized. This can be achieved if, for example, after the first number has exceeded the second number for the first time, further signaling of the detection results is withheld until the first number has reached, or fallen below, the level of the second number.

Advantageously, a repeat takes place due to the absence of an acknowledge message from a receiving radio transmitter/radio receiver. In this way, the reception of a fault-free packet is acknowledged by a positive ACK. With this procedure, the disclosed method realizes its full effect. Using systems that employ this method, it is possible that, although an acknowledgement was sent, it does not arrive at the transmitter of the receiving packet, and the transmitter must thus assume that the packet it has sent was faulty. In such cases, the data packet(s) is/are unjustifiably re-sent and blocks the repeat time-slot. As with radio telecommunications systems in which data packets are transmitted by real-time critical applications and only a once-only repeat is sometimes permitted, a blockage of this kind can cause a noticeable deterioration in the performance of the system.

The frequencies are preferably allocated in such a way that the radio transmitter/radio receiver calculates them itself using an algorithm. This reduces the signaling requirement and thus leads to a more effective use of resources. In addition, this approach guarantees that the allocation of all radio transmitters and radio receivers is immediately available, for example immediately during commissioning.

The calculation using the algorithm preferably takes place using unambiguous identification information known to the radio telecommunications system. Such information is normally provided in every radio standard, particularly those of the new generation. Because this information must be known to each radio transmitter/radio receiver and to the communication partners and is unique, an algorithm that is easy to implement can be used to realize an allocation.

The advantages of the method in accordance with the invention are particularly evident in a radio telecommunications system that functions in accordance with the Digital Enhanced Cordless Telecommunication (DECT) or Worldwide Digital Cordless Telecommunications (WDCT) standard, whereby an International Portable User Identity (IPUI) in accordance with DECT can then advantageously be used as identification information.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a radio telecommunications system using a method according to an exemplary embodiment; and

FIG. 2 illustrates an exemplary spectral representation of a subcarrier allocation in accordance with the embodiment of FIG. 1.

### DETAILED DESCRIPTION

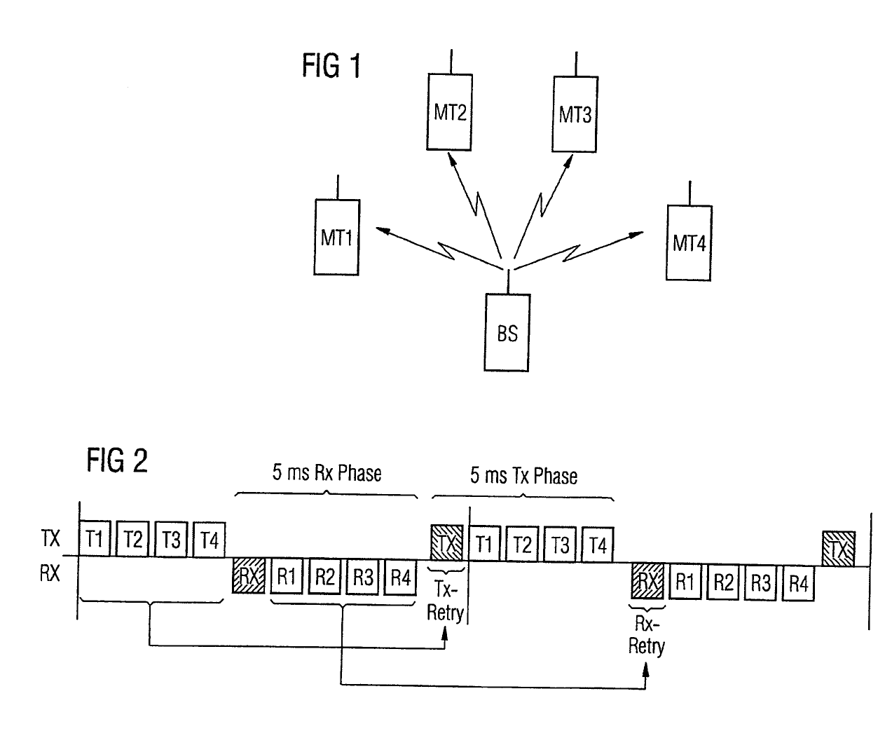

FIG. 1 shows a scenario with a radio telecommunications system that functions in accordance with a DECT standard. Furthermore, a radio coverage area provided by a stationary radio transmitter/radio receiver (base station) BS is shown, in which four mobile radio transmitters/radio receivers (mobile parts) MT1 . . . MT4 are located.

Mobile parts MT1 . . . MT4 are connected to the base station BS through an air interface defined in accordance with DECT. This is shown by the arrows. The base station BS acts as a central device of the radio coverage area and has a switching function such that cordless communication is effected between the mobile parts shown, via the base station BS. For this purpose, the carrier frequencies allocated to the system are divided into time slots that in turn are differentiated as time slots in the transmit direction (Tx) and time slots in the receive direction (Rx).

FIG. 2 shows a framework structure resulting from this configuration, as seen from the point of view of the base station. As the representation shows, a frame lasts a total of 10 ms. This time window of 10 ms is divided, in accordance with the example, into transmit time slots T1 . . . T4 and receive time slots R1 . . . R4, with the time windows being allocated to the mobile parts MT1 . . . MT4.

In accordance with the disclosed embodiment, it is now provided that, if required (i.e., due to a repeat request, a repeat time-slot TX, RX is inserted), a frequency multiplexing taking place during the duration of such repeat time slots TX, RX in such a way that data packets to be repeated are retransmitted on frequencies unambiguously allocated to the user stations BS, MT1 . . . MT4 in the particular radio coverage area. In this case, the data packet to be transmitted is transmitted only on the particular frequency allocated to the user that requested the repeat. In this way, it is therefore possible to serve several user stations in parallel with requested data packetsand, due to the parallel arrangement, incorrect interpretations have the effect that a lost packet acknowledgement is interpreted as a request to repeat and does not have the effect of blocking resources.

In the first time window of the frame shown, it can therefore be seen that there were no repeat requests for the transmit time slots T1 . . . T4 of a previous time window. However, there was clearly at least one request to repeat data packets in the time slots in the receive direction R1 . . . R4, from which it can clearly be seen that a repeat time slot in the receive direction RX is necessary.

In the following time window it can be seen that there are clearly repeat requests both in the receive and transmit directions, because both a repeat time slot for the receive direction RX and also a repeat time slot for the transmit direction TX have been inserted in accordance with the present disclosure (shown by the arrows).

The sequence in the event of a repeat request in the downlink direction in accordance with the invention can be summarized as follows:

If there are several repeat requests by the mobile parts MT1 . . . MT4, the base station BS, by selecting from the frequencies allocated to the mobile parts MT1 . . . MT4 and their use, decides and distributes the requested data packets. Those mobile parts MT1 . . . MT4 that have not requested a repeat receive nothing during the repeat time-slot on the frequencies assigned to them and therefore more or less listen into space so that they can switch off their receivers after an unsuccessful synchronization. The remaining mobile parts MT1 . . . MT4, on the other hand, receive the required data packets on their frequencies.

The sequence in the event of a repeat request in an uplink direction is as follows:

The mobile parts MT1 . . . MT4 that re-send due to the absence of a data packet acknowledgement, do so on the (repeat) frequencies allocated to them in accordance with the present disclosure. The base station BS that detects the allocation of the frequency to the mobile part has set this frequency in anticipation of the repeat requested from it, so that it also only receives the data packet that it wanted to have. If other mobile parts also repeat data packets on the basis of the above misinterpretation, these simply run into space, so that no collisions occur.

It should be understood that the various changes and modifications to the presently preferred embodiments described herein will be apparent to those skilled in the art. For example, dynamic frequency selections may be used as a filter. Furthermore, the disclosed method may also be used for establishing connections to a broadcast channel. Such changes and modifications can be made without departing from the spirit and scope of the present disclosure and without diminishing its intended advantages. It is therefore intended that such changes and modifications be covered by the appended claims.

1-11. (canceled)

12. A method for transmitting packet data in a radio telecommunications system comprising:
allocating a unique identifying frequency to each of a plurality of radio transmitters and radio receivers;
detecting whether a repeat time slot is used;
performing frequency-slot separation on to-be-repeated data packets if a repeat time slot is detected, wherein the frequency-slot separation assigns the to-be-repeated data packets to a respective unique identifying frequency, and wherein the frequency-slot separation is carried out within the duration of the repeat time slot; and
performing frequency selection in at least one of the radio transmitters and receivers wherein a repeated data packet is searched on the respective identifying frequency

13. The method in accordance with claim 12, wherein the step of allocating the unique identifying frequency is performed once as part of an initialization of the radio coverage area, with the allocation being stored at least temporarily in the radio transmitters and radio receivers.

14. The method in accordance with claim 12,, wherein the step of allocating the unique identifying frequency is carried out at the start of each transmission frame in accordance with the time-slot separation method.

15. The method in accordance with claim 12, wherein an allocation of frequencies to radio transmitters and radio receivers is implemented in such a way that each radio transmitter and radio receiver is allocated a sequence with a unique starting value.

16. The method in accordance with claim 12, wherein the frequency-slot separation and selection steps are performed if, in a radio coverage area of the radio telecommunications system, it is determined before the start of a transmission frame that a first number of radio transmitters and radio receivers located in a radio coverage area exceeds a second number in the radio coverage area according to the repeat time slots available with the time-slot separation.

17. The method in accordance with claim 12, wherein the frequency-slot separation and selection steps are performed for each repeat time slot.

18. The method in accordance with claim 12, wherein a repeat time slot is used due to the absence of an acknowledgement message from a receiving radio transmitter/radio receiver.

19. The method in accordance with claim 12, wherein the allocation of frequencies is calculated within each of the radio transmitters and radio receivers.

20. The method in accordance with claim 19, wherein calculation takes place on the basis of unique identifying information known to the radio telecommunications system.

21. The method in accordance with claim 12, wherein the radio telecommunications system operates in accordance with the Digital Enhanced Cordless Telecommunication (DECT) or Worldwide Digital Cordless Telecommunications (WDCT) standard.

22. The method in accordance with claim 12, wherein an International Portable User Identity (IPUI) is used as identification information.
